(19) United States
(12) Patent Application Publication
(10) Pub. No.: US 2019/0251851 A1
(43) Pub. Date: Aug. 15, 2019

(54) NAVIGATION METHOD AND DEVICE BASED ON THREE-DIMENSIONAL MAP

(71) Applicant: SZ DJI TECHNOLOGY CO., LTD., Shenzhen (CN)

(72) Inventors: Kaiyong ZHAO, Shenzhen (CN); Yao YAO, Shenzhen (CN); Yuewen MA, Shenzhen (CN); Shizhen ZHENG, Shenzhen (CN)

(21) Appl. No.: 16/391,806

(22) Filed: Apr. 23, 2019

Related U.S. Application Data
(63) Continuation of application No. PCT/CN2016/105964, filed on Nov. 15, 2016.

(51) Int. Cl. G08G 5/00; B64C 39/02; G01C 21/00; G06T 17/05; G06F 16/29

(52) U.S. Cl. CPC G08G 5/0069; G08G 5/0078; B64C 39/024; B64C 2201/141; G06T 17/05; G06F 16/29; G01C 21/005

(57) ABSTRACT

A navigation method includes obtaining a route mark in a three-dimensional map. The navigation method also includes generating a navigation route based on the route mark, the navigation route circumventing a specified object in the three-dimensional map. The navigation method further includes sending a motion instruction to a movable object based on the navigation route.

### CROSS-REFERENCE TO RELATED APPLICATION

This application is a continuation application of International Application No. PCT/CN2016/105964, filed on Nov. 15, 2016, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technology field of navigation and, more particularly, to a navigation method and a navigation device based on a three-dimensional map and, a method of controlling movable objects, a device, a storage medium, and an unmanned aerial vehicle system.

### BACKGROUND

Currently, similar to ground transportation planning, the planning of navigation routes for unmanned aerial vehicles (UAV) can only be performed based on two-dimensional maps. As a result, adjustment to the position and route of a UAV can only be performed on a horizontal plane. Thus, conventional methods cannot fully utilize the high movability of the UAV in a three-dimensional space. Moreover, conventional methods cannot precisely control the flight route of the UAV in the three-dimensional space. On the other hand, when the UAV flies along the flight route generated based on a two-dimensional map and encounters an obstacle, the only method that can be used to circumvent the obstacle is to raise the flying height. The UAV cannot adopt an optimal flight route otherwise available in a three-dimensional space for circumventing the obstacle. In addition, the conventional methods for circumventing the obstacle also require multiple suspensions until the body of the UAV becomes stable. Accordingly, conventional methods may result in a waste of valuable flight time of the UAV.

### SUMMARY

In order to solve the current issues and other potential issues related to the current technology, the present disclosure provides a navigation method and a navigation device based on a three-dimensional map. The present disclosure also provides a method for controlling movable objects, a device, a storage medium, and a UAV system.

In accordance with the present disclosure, there is provided a navigation method. The navigation method includes obtaining a route mark in a three-dimensional map. The navigation method also includes generating a navigation route based on the route mark, the navigation route circumventing a specified object in the three-dimensional map. The navigation method further includes sending a motion instruction to a movable object based on the navigation route.

In accordance with the present disclosure, there is also provided a navigation device. The navigation device includes at least one processor individually or collectively configured to obtain a route mark in a three-dimensional map. The at least one processor is also configured to generate a navigation route based on the route mark, the navigation route circumventing a specified object in the three-dimensional map. The navigation device also includes a transmitter configured to send a motion instruction to a movable object based on the navigation route.

In various embodiments of the present disclosure, because information about the three-dimensional map and three-dimensional operations are used, the flight route of the UAV can be more accurately or precisely controlled, thereby satisfying complex photographing needs. In addition, through pre-set precise flight routes and workflow, unmanned surveillance or surveillance that uses few human resources can be automated.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a flow chart illustrating a navigation method based on a three-dimensional map according to an example embodiment.

FIG. 2 is a flow chart illustrating a method of obtaining a route mark in a three-dimensional map according to an example embodiment.

FIG. 3 is a flow chart illustrating a method of obtaining a screen position of a route mark according to an example embodiment.

FIG. 4 is a flow chart illustrating a method of generating a navigation route based on the route mark according to an example embodiment.

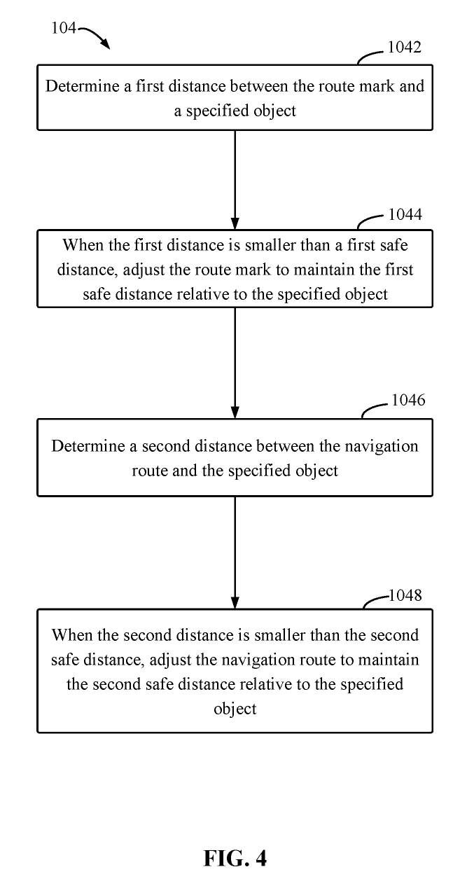

FIG. 5 is a flow chart illustrating a method of obtaining the screen position of a route mark according to an example embodiment.

FIG. 6 is a schematic diagram of a navigation device based on a three-dimensional map according to an example embodiment.

FIG. 7 is a schematic diagram of a navigation device based on a three-dimensional map according to another example embodiment.

FIG. 8 is a schematic diagram of a device for controlling a movable object according to an example embodiment.

FIG. 9 is a schematic diagram of a device for controlling a movable object according to another example embodiment.

### DETAILED DESCRIPTION OF THE EMBODIMENTS

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Example embodiments will be described with reference to the accompanying drawings, in which the same numbers refer to the same or similar elements unless otherwise specified.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “left,” “right,” “up,” “upward,” “upwardly,” “down,” “downward,” “downwardly,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

The term “communicatively coupled” indicates that related items are coupled through a communication channel, such as a wired or wireless communication channel.

The term “curve” includes either a straight line or a curve.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined.

The following embodiments do not limit the sequence of execution of the steps included in the disclosed methods. The sequence of the steps may be any suitable sequence, and certain steps may be repeated.

In the present disclosure, the “screen position” refers to three-dimensional coordinates that are formed by two-dimensional coordinates and a projection distance relative to the screen. The “map position” refers to three-dimensional coordinates in a three-dimensional map. The “global position” refers to the longitude, latitude, and elevation in the real world.

In the present disclosure, a movable object may be a UAV. However, in the present disclosure, the movable object is not limited to a UAV. The movable object may be any movable object in a three-dimensional space that may or may not be able to carry people or objects.

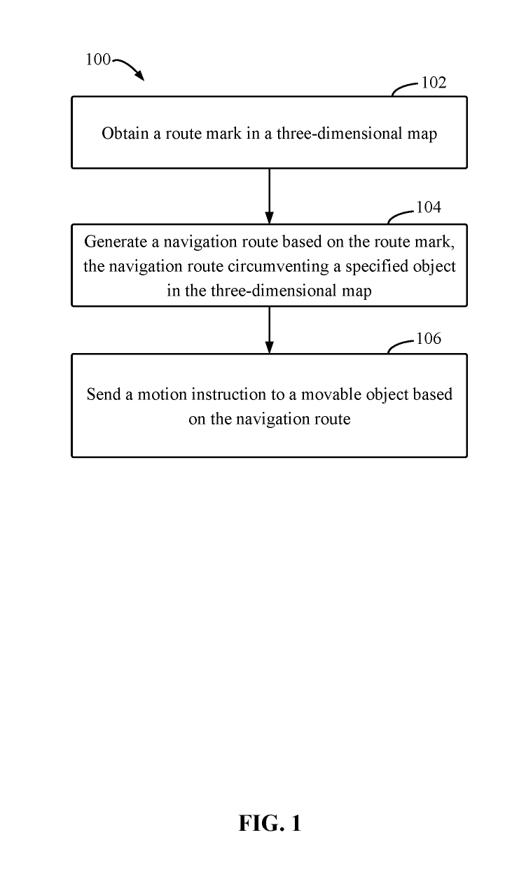

FIG. 1 is a flow chart illustrating a navigation method 100 based on a three-dimensional map.

In step 102, a processor (any suitable processor disclosed herein) may obtain a route mark in a three-dimensional map.

In some embodiments, the three-dimensional map is pre-constructed. Methods for constructing the three-dimensional map include, but are not limited to, methods based on videos captured by UAV, algorithm reconstruction by a three-dimensional (3D) scanner, mathematical modeling of the videos using software that is similar to Autodesk's 3ds Max. In some embodiments, the three-dimensional map may be generated or constructed based on the images and/or videos captured by the UAV. The present disclosure does not limit the methods for constructing or generating the three-dimensional map. Any suitable methods for constructing or generating the three-dimensional map fall within the scope of the present disclosure.

In some embodiments, based on a present position of a user or a movable object, the processor may obtain a three-dimensional map corresponding to the present position. In some embodiments, a three-dimensional map may be obtained for an area that is within a predetermined range of the present position. For example, the processor may obtain a three-dimensional map for an area having a predetermined radius from the present position. The radius may be 100 meters, 200 meters, 500 meters, 1000 meters, 2000 meters, 5000 meters, 7000 meters, or 10000 meters. In some embodiments, the processor may determine the predetermined range based on a range of motion of the movable object or based on an input from a user. The predetermined range may be any suitable value.

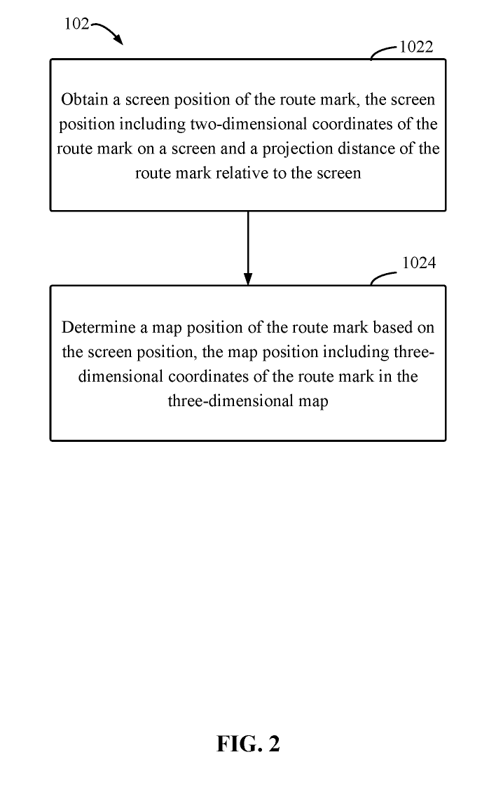

In some embodiments, as shown in FIG. 2, in step 102, obtaining the route mark in the three-dimensional map may include a step 1022, obtaining a screen position of the route mark. The screen position may include two-dimensional coordinates of the route mark on the screen and a projection distance of the route mark relative to the screen. The step 102 may also include a step 1024, determining a map position of the route mark based on the screen position, the map position including three-dimensional coordinates of the route mark in the three-dimensional map. As such, the three-dimensional coordinates of the route mark can be accurately determined based on the two-dimensional coordinates on the screen and the projection distance.

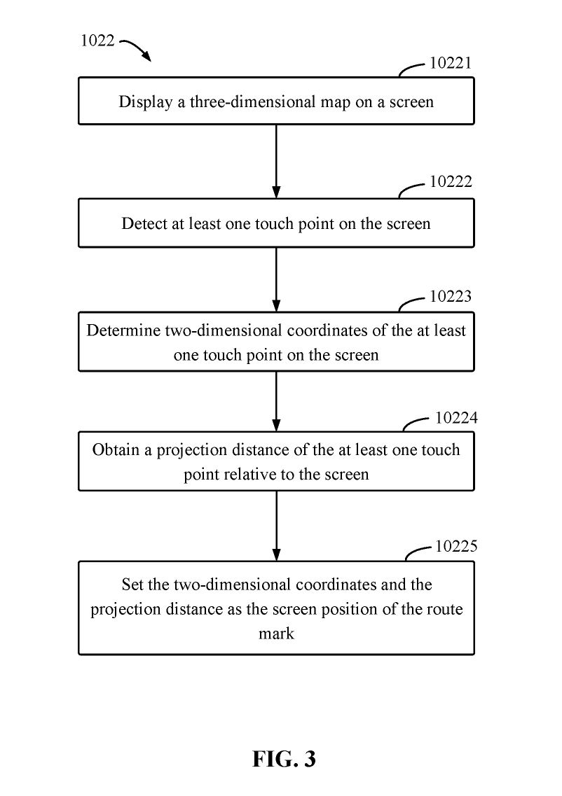

In some embodiments, as shown in FIG. 3, in step 1022, obtaining the screen position of the route mark may also include: a step 10221, displaying the three-dimensional map on the screen. The step 1022 may also include a step 10222, detecting at least one touch point on the screen. The step 1022 may also include a step 10223, determining two-dimensional coordinates of the at least one touch point on the screen. The step 1022 may also include a step 10224, obtaining a projection distance of the at least one touch point relative to the screen. The step 1022 may also include a step 10225, setting the two-dimensional coordinates and the projection distance as the screen position of the route mark.

In some embodiments, the three-dimensional map is displayed on the screen. A user may view the three-dimensional map and select a touch point on the screen. A screen sensor may detect the position of the touch point. Based on this position, the processor may obtain the two-dimensional screen coordinates (xs, ys) on the x-axis and the y-axis for the touch point.

In some embodiments, obtaining a projection distance of the at least one touch point relative to the screen may include obtaining the projection distance based on a value associated with a scroll bar displayed on the screen. In some embodiments, the value may be a numerical value.

In some embodiments, the processor may obtain the projection distance on the z-axis based on the value associated with the scroll bar displayed on the screen. The input range of the scroll bar may be −H to +H, where the value of the parameter H may be determined based on actual applications, such as 0.1 meter, 0.2 meter, 0.5 meter, 1 meter, 10 meters, 100 meters, or 1000 meters. For example, the input value of the scroll bar may be represented by h, which is the projection distance of the touch point relative to the screen. Based on the two-dimensional screen coordinates (xs, ys) and the projection distance h, the screen position may be set as (xs, ys, h).

In some embodiments, the screen sensor may detect any number of touch points, such as one or more than one touch point. In some embodiments, the at least one touch point may include multiple continuous touch points that form a curve. In some embodiments, an activating button may be provided on the screen. In some embodiments, only when the activating button is activated, the screen sensor would treat the screen-touching operations as operations for selecting a route mark.

In some embodiments, the at least one touch point includes multiple continuous touch points, i.e., a curve. Each touch point on the curve may have the same projection distance or different projection distances relative to the screen. Through the two-dimensional coordinates and the projection distance associated with each touch point on the curve, the three-dimensional coordinates of each touch point on the curve may be accurately determined.

In some embodiments, a user may draw a navigation curve on the three-dimensional map. For example, the user may manipulate the three-dimensional map to find a suitable location and a suitable view point. The user may use the scroll bar to set a depth of the navigation curve relative to a virtual projection camera related to the screen, thereby setting a plane. The plane may move in real time as the scroll bar is moved. In some embodiments, the plane may be displayed in color, and may enable the user to distinguish objects in front of the plane from objects behind the plane. In some embodiments, the user may adjust the depth. After the plane is set, the user may continue to draw the navigation curve on the plane.

In some embodiments, after the user draws the navigation curve, the processor may determine the screen position of the navigation curve based on two-dimensional screen coordinates and a value of the scroll bar. For example, the processor may sample a plurality of points from the navigation curve, obtain the screen position of each point, and re-generate the navigation curve (or update the navigation curve) based on the screen position of each point.

In some embodiments, instead of touching the screen, the user may also add a route mark through a dragging operation. For example, a list of route marks (e.g., navigation marks) may be provided in a menu bar displayed, for example, at the edge of the screen. The user may drag a route mark from the menu bar directly to the three-dimensional map using an input device (e.g., a mouse and a cursor displayed on the screen) or using a finger. The navigation mark may be added to the three-dimensional map. After the dragging operation is completed, one or more new route marks may be displayed in the menu bar.

In some embodiments, determining the map position of the route mark based on the screen position may include: obtaining the three-dimensional coordinates of the virtual projection camera related to the screen in the three-dimensional map and an angle between the virtual projection camera related to the screen and the route mark; and calculating the map position of the route mark based on the three-dimensional coordinates of the virtual projection camera, the angle, and the screen position. In some embodiments, a point in the three-dimensional map may be set as an origin (0, 0, 0). The three-dimensional coordinates (xc, yc, zc) of the virtual projection camera in the three-dimensional map may be obtained based on the present projection angle of the screen. Subsequently, based on the three-dimensional coordinates (xc, yc, zc), the angle between the virtual projection camera and the route mark, and screen position (xs, ys, h), the processor can calculate the map position (xm, ym, zm) of the route mark in the three-dimensional map. The method for calculating the map position (xm, ym, zm) may be any suitable method.

In some embodiments, the screen may include one or more of a rotation button, a translation button, and an elevation joystick. The rotation button, translation button, and elevation joystick may be physical items or may be virtual items displayed on the screen. For example, the screen may display a rotation button. When the rotation button is clicked, the processor may display a rotation mode on the screen. In the rotation mode, a dragging operation in the left and right direction by a user may cause an adjustment to an azimuth angle of the field of view, and a dragging operation in the up and down direction may cause an adjustment to a pitch angle of the field of view. When the translation button is clicked, the processor may display a translation mode on the screen. In the translation mode, a dragging operation in the left and right direction may cause a translation in the left and right direction in a horizontal plane, and a dragging operation in the up and down direction may cause a translation in the front and back direction in the horizontal plane. In some embodiments, the elevation joystick may be used to adjust a height of the field of view. Dragging downwardly may cause the UAV to descend, and dragging upwardly may cause the UAV to ascend. Under any mode, the user may use two fingers to perform a multi-touch operation, e.g., to zoom in and zoom out of a map. In some embodiments, the rotation button and the translation button may be combined as a single button, and may switch the rotation and translation modes based on an input from the user (e.g., a click operation).

In some embodiments, the route mark may include the map position of the movable object in the three-dimensional map. In some embodiments, obtaining the route mark in the three-dimensional map may include: obtaining the global position of the movable object, the global position including the longitude, altitude, and elevation of the movable object; and calculating the map position of the movable object based on the global position. The processor may generate a navigation route based on and starting from the present position of the movable object.

In some embodiments, obtaining the global position may use any suitable technology. For example, the global position in the physical world may be obtained using the Global Positioning System (“GPS”), Assisted or Augmented GPS (“AGPS”), elevation sensors, simultaneous localization and mapping (“SLAM”), etc. For example, the global position of the movable object may be represented by (lat, lon, hw), where lat represents the latitude of the movable object, lon represents the longitude of the movable object, and hw represents the elevation of the movable object. The map position (xm, ym, zm) of the movable object in the three-dimensional map may be obtained based on the global position (lat, Ion, hw). The method for converting the global position to the map position may use any suitable algorithm.

Referring to FIG. 1, in step 104, the processor may generate a navigation route based on the route mark.

In some embodiments, step 104 may include: step 1042, determining a first distance between the route mark and the specified object; step 1044, when the first distance is smaller than a first safe distance, adjusting the route mark to maintain the first safe distance relative to the specified object; step 1046, determining a second distance between the navigation route generated based on the route mark and the specified object; step 1048, when the second distance is smaller than a second safe distance, adjusting the navigation route to maintain the second safe distance relative to the specified object. In some embodiments, the specified object may be an obstacle (e.g., building, mountain, bridge, tree, etc.) or a no-fly zone (e.g., airport, military zone, etc.). The disclosed method can control the movable object to circumvent the obstacle or non-fly zone.

In some embodiments, the first safe distance and the second safe distance may be any suitable distance, such as 0.01 meter, 0.02 meter, 0.05 meter, 0.1 meter, 0.2 meter, 0.5 meter, 1 meter, 2 meters, 5 meters, or 10 meters, etc. Other suitable values may be used for the first safe distance and the second safe distance.

In some embodiments, the route mark may include at least two navigation points. In some embodiments, generating the navigation route based on the route mark may include connecting the at least two navigation points to generate the navigation route. In some embodiments, when connecting the at least two navigation points, subject to the condition of circumventing the specified object (e.g., obstacle, no-fly zone, etc.), the processor may generate the connected curve to have the shortest length, thereby saving the energy consumption for the movable object.

In some embodiments, the route mark may include at least one curve. In some embodiments, generating the navigation route based on the route mark may include setting the at least one curve as the navigation route or as a part of the navigation route. The disclosed method may control the movable object to move along an expected curve.

In some embodiments, after generating the navigation route, the processor may re-generate or update the route marks by removing or modifying a route mark, or adding an additional route mark. The processor may re-generate or update the navigation route based on the re-generated or updated route marks. In the disclosed method, an adjustment to the navigation route may be made at any desirable time.

In some embodiments, the processor may save or store the navigation route as a historical navigation route. The saved historical navigation route may be used more than one time. For example, when the photographing can be performed along a fixed route, a professional operator may first determine the navigation route and determine whether the photos and/or videos captured by the movable object satisfy the photographing requirement. Subsequently, a user can simply retrieve or select a navigation route prepared by the professional operator for controlling the movable object to capture images and/or videos having similar effects. In some embodiments, a user may adjust the navigation route prepared by the professional operator during the photographing process to satisfy specific or additional requirements.

Referring to FIG. 1, in step 106, the processor may send a motion instruction to the movable object based on the navigation route.

In some embodiments, sending the motion instruction to the movable object based on the navigation route may include: obtaining the map positions in the three-dimensional map for a plurality of sampling points on the navigation route; calculating the global positions of the sampling points based on the map positions; and sending the global positions of the sampling points to the movable objects. According to the disclosed methods, the movable object may be controlled to pass through the global positions of the sampling points, thereby flying substantially along the navigation route.

In some embodiments, sending the motion instruction to the movable object based on the navigation route may include: generating a control instruction for controlling a propulsion system or device of the movable object based on the navigation route; and sending the control instruction to the movable object. In some embodiments, the control instruction may be used to generate a pulse width modulation (“PWM”) control signal. The disclosed method may enable controlling of the movable object to move based on the control instruction, thereby simplifying the process for controlling the motion of the movable object.

In some embodiments, sending the motion instruction to the movable object based on the navigation route may include sending the navigation route to the movable object. In this manner, the process of the navigation route may be performed on the movable object.

In some embodiments, the navigation method shown in FIG. 1 may also include: obtaining, in real time, the global position of the movable object; calculating the map position of the movable object in the three-dimensional map based on the global position, and when the map position deviates from the navigation route, sending a motion correction instruction to the movable object. In this manner, the processor may correct, in real time, the route of the movable object, using closed-loop control.

In the navigation method of the present disclosure, the navigation route may be planned based on a three-dimensional map. The disclosed navigation method can satisfy photographing requirements under complex spatial routes, such as when shooting extreme sports, movies, etc. In some embodiments, the navigation method can precisely or accurately reconstruct a three-dimensional model. The disclosed navigation method may enable route planning for a work UAV (e.g., an agriculture UAV, a power line UAV, a logistics UAV, etc.), such that no manual operation is needed during a specific work process, thereby improving efficiency.

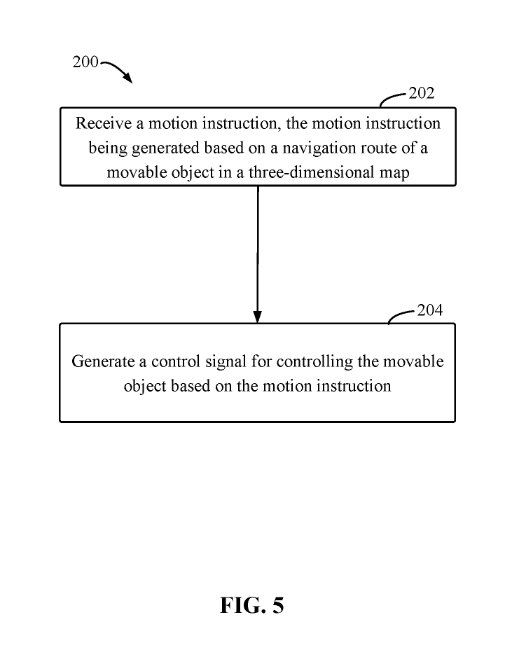

FIG. 5 is a flow chart illustrating a method for controlling the movable object.

As shown in FIG. 5, in step 202, the processor may receive a motion instruction. The motion instruction is generated based on a navigation route of a movable object in a three-dimensional map.

In some embodiments, receiving the motion instruction may include receiving global positions of multiple sampling points on the navigation route. In this manner, the movable object can be controlled to pass through the global positions of the multiple sampling points, thereby flying substantially along the navigation route.

In some embodiments, receiving the motion instruction may include receiving a control instruction for controlling a propulsion system or device of the movable object. In some embodiments, the control instruction may be used to generate a PWM control signal. In this manner, the movable object may move according to the control instructions, thereby simplifying the process for controlling the motion of the movable object.

In some embodiments, receiving the motion instruction may include receiving the navigation route. In this manner, the navigation route may be processed on the movable object.

Referring back to FIG. 5, in step 204, the processor may generate a control signal for controlling the movable object based on the motion instruction.

In some embodiments, generating the control signal for controlling the movable object based on the motion instruction may include generating, based on the global positions of the multiple sampling points, a control signal for controlling the movable object to fly through the global positions of the multiple sampling points. In some embodiments, the movable object may obtain its present position through a position sensor carried by the movable object. The movable object may plan an operating route (e.g., a navigation route) based on the present position and the global positions of the sampling points, and may fly along the operating route.

In some embodiments, generating a control signal for controlling the movable object based on the motion instruction may include generating a control signal for controlling a propulsion system or device of the movable object based on a control instruction. In some embodiments, the movable object may control its propulsion system or device based on the control instruction. In some embodiments, the control signal may be a PWM control signal.

In some embodiments, controlling the movable object based on the motion instruction may include: obtaining the map positions of the multiple sampling points on the navigation route in the three-dimensional map; calculating the global positions of the multiple sampling points based on the map position; and generating, based on the global positions of the sampling points, a control signal for controlling the movable object to fly through the multiple sampling points.

In some embodiments, controlling the movable object based on the motion instruction may include generating a control instruction based on the navigation route; and generating a control signal for controlling the propulsion system or device of the movable object based on the control instruction. In some embodiments, the control signal is a PWM control signal.

In some embodiments, the method shown in FIG. 5 also includes: detecting, in real time, a global position of the movable object; sending the global position; receiving a motion correction instruction; and in response to receiving the motion correction instruction, generating a correction signal for correcting a route of motion (e.g., a navigation route) of the movable object. In some embodiments, the global position in the physical world may be obtained using the Global Positioning System (“GPS”), Assisted or Augmented GPS (“AGPS”), elevation sensors, simultaneous localization and mapping (“SLAM”), etc. In some embodiments, the movable object may transmit the global position to a processor through any suitable communication channels or media, such as infrared, Bluetooth, near field communication, Wi-Fi, ZigBee, wireless USB, wireless radio frequency, and other methods based on 2.4 GHz or 5.8 GHz wireless communication. In some embodiments, the UAV may correct the route of motion of the movable object using a PWM correction signal.

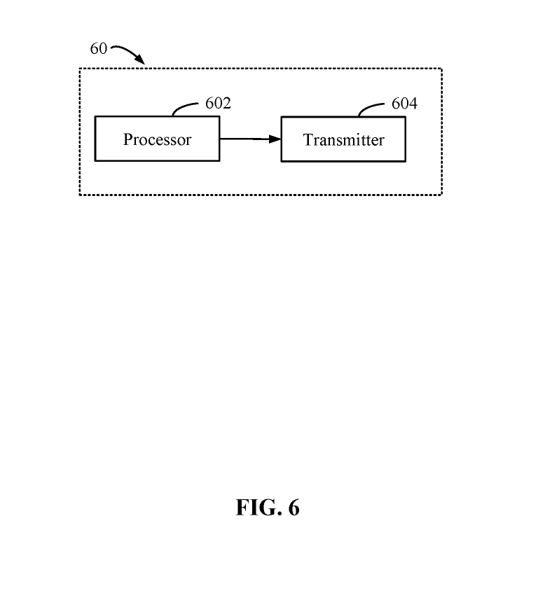

FIG. 6 is a schematic diagram of a navigation device based on a three-dimensional map.

As shown in FIG. 6, a navigation device 60 may include at least one processor 602 and a transmitter 604. The at least one processor 602 may be configured to obtain a route mark in a three-dimensional map, and to generate a navigation route based on the route mark. The navigation route circumvents a specified object in the three-dimensional map. The transmitter 604 may be configured to send a motion instruction to the movable object based on the navigation route. Although only one processor 602 is shown in this embodiment, the present disclosure does not limit the number of processors. In some embodiments, the navigation device 60 may include multiple processors individually or collectively configured to obtain the route mark in the three-dimensional map, and to generate the navigation route based on the route mark. The navigation route circumvents a specified object in the three-dimensional map.

In some embodiments, the at least one processor 602 is configured to obtain a screen position of the route mark. The screen position may include two-dimensional coordinates of the route mark on the screen and a projection distance of the route mark relative to the screen. The at least one processor 602 may also be configured to determine a map position of the route mark based on a screen position, the map position including three-dimensional coordinates of the route mark in the three-dimensional map.

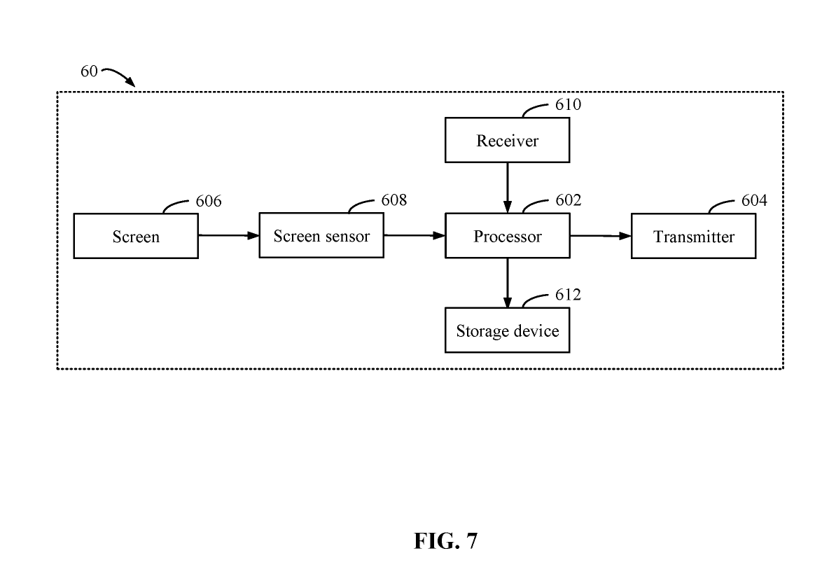

In some embodiments, as shown in FIG. 7, the navigation device 60 may include: a screen 606 configured to display the three-dimensional map; and a screen sensor 608 configured to detect at least one touch point on the screen 606. The at least one processor 602 may be configured to: obtain two-dimensional coordinates of the at least one touch point on the screen 606; obtain a projection distance of the at least one touch point relative to the screen 606; and set the two-dimensional coordinates and the projection distance as the screen position of the route mark.

In some embodiments, the at least one touch point may include multiple continuous touch points that form a curve.

In some embodiments, the at least one processor 602 may be configured to obtain the projection distance based on a value associated with a scroll bar provided on the screen 606.

In some embodiments, the at least one processor 602 may be configured to: obtain the map position of a virtual projection camera related to the screen in the three-dimensional map and an angle between the virtual projection camera and the route mark; and calculate a map position of the route mark based on the map position of the virtual projection camera, the angle, and the screen position.

In some embodiments, the at least one processor 602 may be configured to: determine a first distance between the route mark and the specified object; when the first distance is smaller than a first safe distance, adjust the route mark to maintain the first safe distance relative to the specified object; determine a second distance between the navigation route and the specified object; and when the second distance is smaller than a second safe distance, adjust the navigation route to maintain a second safe distance relative to the specified object.

In some embodiments, the specified object may be an obstacle or a no-fly zone.

In some embodiments, the route mark may include the map position of the movable object in the three-dimensional map. The at least one processor 602 may be configured to: obtain the global position of the movable object, the global position including the longitude, altitude, and elevation of the movable object; and calculate the map position of the movable object based on the global position.

In some embodiments, the at least one processor 602 may be configured to: re-generate or update the route marks by removing or modifying a route mark, or adding an additional route mark; and re-generate or update the navigation route based on the re-generated or updated route marks.

In some embodiments, as shown in FIG. 7, the navigation device 60 may include a storage device 612 configured to store the navigation route as a historical navigation route.

In some embodiments, the route mark may include at least two navigation points.

The at least one processor 602 may be configured to connect the at least two navigation points to generate the navigation route.

In some embodiments, the route mark may include at least one curve. The at least one processor 602 may be configured to set the at least one curve as the navigation route or as a part of the navigation route.

In some embodiments, the at least one processor 602 may be configured to: obtain the map positions of the multiple sampling points on the navigation route in the three-dimensional map; and calculate the global positions of the multiple sampling points based on the map positions. The transmitter 604 may be configured to send the global positions of the sampling points to the movable object.

In some embodiments, the at least one processor 602 may be configured to generate a control instruction for controlling a propulsion device or system of the movable object based on the navigation route. The transmitter 604 may be configured to send the control instruction to the movable object.

In some embodiments, the transmitter 604 may be configured to send the navigation route to the movable object.

In some embodiments, as shown in FIG. 7, the navigation device 60 may include a receiver 610 configured to receive, in real time, the global position of the movable object. The at least one processor 602 may be configured to calculate the map position of the movable object in the three-dimensional map based on the global position. The transmitter 604 may be configured to, when the map position deviates from the navigation route, send a motion correction instruction to the movable object.

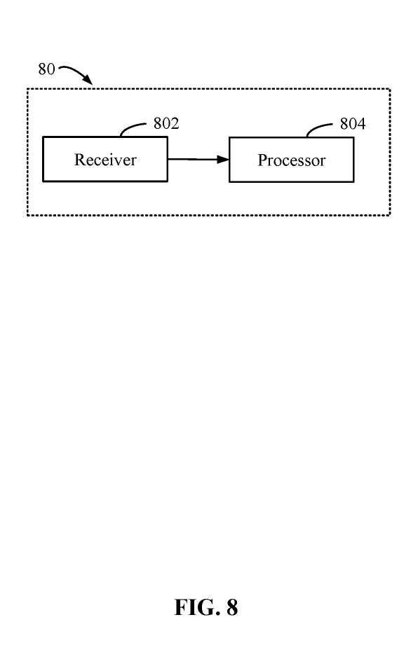

FIG. 8 is a schematic diagram of a device for controlling the movable object.

As shown in FIG. 8, a device 80 may include a receiver 802 configured to receive a motion instruction. The motion instruction may be generated based on the navigation route in the three-dimensional map. The device 80 may also include at least one processor 804 individually or collectively configured to generate a control signal for controlling the movable object based on the motion instruction. Although FIG. 8 shows only one processor 804, the present disclosure is not limited to one processor, and other suitable number of multiple processors may also be used. The multiple processors may operate in collaboration to generate the control signal for controlling the movable object based on the motion instruction.

In some embodiments, the receiver 802 is also configured to receive the global positions of the multiple sampling points on the navigation route. The at least one processor 804 may be configured to generate, based on the global positions of the sampling points, a control signal for controlling the movable object to fly through the multiple sampling points.

In some embodiments, the receiver 802 is also configured to receive the control instruction for controlling the propulsion system or device of the movable object. The at least one processor 804 may be configured to generate the control signal for controlling the propulsion system or device of the movable object based on the control instruction.

In some embodiments, the receiver 802 is also configured to receive the navigation route. The at least one processor 804 may be configured to: obtain the map positions of the sampling points on the navigation route; calculate the global positions of the sampling points based on the map positions; and generate, based on the global positions of the sampling points, a control signal for controlling the movable object to pass through the sampling points.

In some embodiments, the receiver 802 is also configured to receive the navigation route. The at least one processor 804 may be configured to: generate a control instruction based on the navigation route; and generate a control signal for controlling a propulsion system or device of the movable object based on the control instruction.

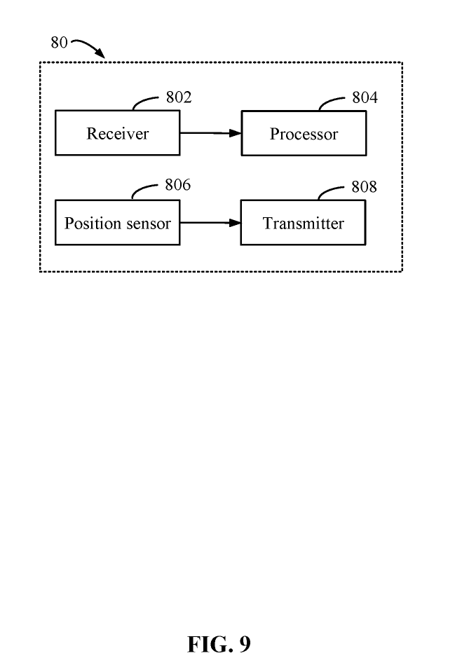

In some embodiments, as shown in FIG. 9, the device 80 may also include: a position sensor 806 configured to detect, in real time, the global position of the movable object; and a transmitter 808 configured to transmit the global position. The receiver 802 may be configured to receive the motion correction instruction. The at least one processor 804 may be configured to generate, in response to receiving the motion correction instruction, a correction signal for correcting the route of motion (e.g., the navigation route) of the movable object.

Embodiments of the present disclosure provide a storage medium or device. The storage medium may be configured to store instructions, which when executed by a processor, cause the processor to perform a navigation method based on a three-dimensional map. The navigation method may include: obtaining a route mark in a three-dimensional map; generating a navigation route based on the route mark, the navigation route circumventing a specified object in the three-dimensional map; and sending a motion instruction to a movable object based on the navigation route.

Embodiments of the present disclosure provide a storage medium or device. The storage medium may be configured to store instructions, which when executed by a processor, cause the processor to perform a method of controlling a movable object. The method may include: receiving a motion instruction, the motion instruction being generated based on the navigation route of the movable object in the three-dimensional map; and generating a control signal for controlling the movable object based on the motion instruction.

Embodiments of the present disclosure provide a UAV system. The UAV system may include a device for controlling a movable object. The device may include a receiver configured to receive a motion instruction, the motion instruction being generated based on a navigation route of a UAV in a three-dimensional map. The device may also include at least one processor individually or collectively configured to generate a control signal for controlling the UAV based on the motion instruction. The UAV system may also include a propulsion system or device configured to drive the UAV based on the control signal.

The processor of the present disclosure may include a central processing unit (“CPU”), a network processor (“NP”), or a combination of the CPU and NP. In some embodiments, the processor may include a hardware chip. The hardware chip may be an application-specific integrated circuit (“ASIC”), a programmable logic device (“PLD”), or a combination of the ASIC and PLD. The PLD may be complex programmable logic device (“CPLD”), field-programmable gate array (“FPGA”), generic array logic (“GAL”), or any combination thereof.

The transmitter and receiver of the present disclosure may be based on any suitable technology, such as infrared, Bluetooth, near-field communication, Wi-Fi, ZigBee, wireless USB, radio frequency, or any other wireless communication method based on 2.4 GHz or 5.8 GHz.

The system and method of the present disclosure may be implemented in various types of UAV. For example, the UAV may be a small UAV. In some embodiments, the UAV may be a rotorcraft, such as a multi-rotor rotorcraft powered by multiple propulsion systems or devices that use air to provide a propulsion force. The present disclosure does not limit the type of the UAV. The UAV may be other types of UAV or movable object.

A person having ordinary skill in the art can appreciate that part or all of the above disclosed methods and processes may be implemented using related electrical hardware, or a combination of electrical hardware and computer software that may control the electrical hardware. Whether the implementation is through hardware or software is to be determined based on specific application and design constraints. A person of ordinary skill in the art may use different methods for different applications. Such implementations fall within the scope of the present disclosure.

A person having ordinary skill in the art can appreciate that descriptions of the functions and operations of the system, device, and unit can refer to the descriptions of the disclosed methods.

A person having ordinary skill in the art can appreciate that the various system, device, and method illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using interfaces. The indirect couplings or communication connections between devices or units or components may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. The actual configuration or distribution of the units or components may be selected or designed based on actual need of applications.

Various functional units or components may be integrated in a single processing unit, or may exist as separate physical units or components. In some embodiments, two or more units or components may be integrated in a single unit or component. The integrated units may be realized using hardware, or may be realized using hardware and software functioning unit.

The disclosed functions may be realized using software functioning units and may be sold or used as an independent product. The software functioning units may be stored in a computer-readable medium as instructions or codes, such as a non-transitory computer-readable storage medium. Thus, the disclosed methods may be realized using software products. The computer software product may be stored in the computer-readable medium in the form of codes or instructions, which are executable by a computing device (e.g., a personal computer, a server, or a network device, etc.) or a processor to perform all or some of the steps of the disclosed methods. The non-transitory computer-readable storage medium can be any medium that can store program codes, for example, a USB disc, a portable hard disk, a read-only memory (ROM), a random access memory (RAM), a magnetic disk, an optical disk, etc.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A navigation method, comprising:
obtaining a route mark in a three-dimensional map;
generating a navigation route based on the route mark, the navigation route circumventing a specified object in the three-dimensional map; and
sending a motion instruction to a movable object based on the navigation route.

2. The navigation method of claim 1, wherein obtaining the route mark in the three-dimensional map comprises:
obtaining a screen position of the route mark, the screen position comprising two-dimensional coordinates of the route mark on a screen and a projection distance of the route mark relative to the screen; and
determining a map position of the route mark based on the screen position, the map position comprising three-dimensional coordinates of the route mark in the three-dimensional map.

3. The navigation method of claim 2, wherein obtaining the screen position of the route mark comprises:
displaying the three-dimensional map on the screen;
detecting at least one touch point on the screen;
determining two-dimensional coordinates of the at least one touch point on the screen;
obtaining a projection distance of the at least one touch point relative to the screen; and
setting the two-dimensional coordinates and the projection distance as the screen position of the route mark.

4. The navigation method of claim 3, wherein the at least one touch point comprises multiple continuous touch points that form a curve.

5. The navigation method of claim 3, wherein obtaining the projection distance of the at least one touch point relative to the screen comprises:
obtaining the projection distance based on a value associated with a scroll bar displayed on the screen.

6. The navigation method of claim 2, wherein determining the map position of the route mark based on the screen position comprises:
obtaining a map position of a virtual projection camera related to the screen in the three-dimensional map and an angle between the virtual projection camera and the route mark; and
calculating the map position of the route mark based on the map position of the virtual projection camera, the angle between the virtual projection camera and the route mark, and the screen position of the route mark.

7. The navigation method of claim 1, wherein generating the navigation route based on the route mark comprises:
determining a first distance between the route mark and the specified object;
when the first distance is smaller than a first safe distance, adjusting the route mark to maintain the first safe distance relative to the specified object;
determining a second distance between the navigation route and the specified object; and
when the second distance is smaller than a second safe distance, adjusting the navigation route to maintain the second safe distance relative to the specified object.

8. The navigation method of claim 1, wherein the specified object is an obstacle or a no-fly zone.

9. The navigation method of claim 1,
wherein the route mark comprises a map position of the movable object in the three-dimensional map, and
wherein obtaining the route mark in the three-dimensional map comprises:
obtaining a global position of the movable object, the global position comprising latitude, longitude, and elevation of the movable object; and
calculating the map position of the movable object based on the global position.

10. The navigation method of claim 1, further comprising:
updating route marks included in the navigation route by at least one of removing or modifying the route mark, or adding an additional route mark; and
re-generating the navigation route based on the updated route marks.

11. The navigation method of claim 1, further comprising:
storing the navigation route as a historical navigation route.

12. The navigation method of claim 1,
wherein the route mark comprises at least two navigation points, and
wherein generating the navigation route based on the route mark comprises:
connecting the at least two navigation points to generate the navigation route.

13. The navigation method of claim 1,
wherein the route mark comprises at least one curve, and
wherein generating the navigation route based on the route mark comprises:
setting the at least one curve as the navigation route or as a part of the navigation route.

14. The navigation method of claim 1, wherein sending the motion instruction to the movable object based on the navigation route comprises:
obtaining map positions of a plurality of sampling points on the navigation route in the three-dimensional map;
calculating global positions of the plurality of sampling points based on the map positions; and
sending the global positions of the plurality of sampling points to the movable object.

15. The navigation method of claim 1, wherein sending the motion instruction to the movable object based on the navigation route comprises:
generating a control instruction for controlling a propulsion device of the movable object based on the navigation route; and
sending the control instruction to the movable object.

16. The navigation method of claim 1, wherein sending the motion instruction to the movable object based on the navigation route comprises:
sending the navigation route to the movable object.

17. The navigation method of claim 1, further comprising:
obtaining, in real time, a global position of the movable object;
calculating a map position of the movable object in the three-dimensional map based on the global position; and
when the map position deviates from the navigation route, sending a motion correction instruction to the movable object.

18. A navigation device, comprising:
at least one processor individually or collectively configured to:
obtain a route mark in a three-dimensional map; and
generate a navigation route based on the route mark, the navigation route circumventing a specified object in the three-dimensional map; and
a transmitter configured to send a motion instruction to a movable object based on the navigation route.

19. The navigation device of claim 18, wherein the at least one processor is further configured to:
obtain a screen position of the route mark, the screen position comprising two-dimensional coordinates of the route mark on a screen and a projection distance of the route mark relative to the screen; and
determine a map position of the route mark based on the screen position, the map position comprising three-dimensional coordinates of the route mark in the three-dimensional map.

20. The navigation device of claim 19, wherein the screen is configured to display the three-dimensional map,
the navigation device further comprising a screen sensor configured to detect at least one touch point on the screen,
wherein the at least one processor is further configured to:
determine two-dimensional coordinates of the at least one touch point on the screen;
obtain a projection distance of the at least one touch point relative to the screen; and
set the two-dimensional coordinates and the projection distance as the screen position of the route mark.
